(19) United States
(12) Patent Application Publication
(10) Pub. No.: US 2020/0148564 A1
(43) Pub. Date: May 14, 2020

(54) PORTABLE WATER PURIFIER

(71) Applicant: Reliance Worldwide Corporation, Atlanta, GA (US)

(72) Inventors: Zvi Ben-Shalom, Hof Ashkelon (IL); Zeev AIZENSHTAT, Jerusalem (IL); Mordechai VIZEL, Jerusalem (IL); Meir BADALOV, Netanya (IL); Barouch BAHAT, Tel Aviv (IL)

(73) Assignee: Reliance Worldwide Corporation, Atlanta, GA (US)

(21) Appl. No.: 16/719,374

(22) Filed: Dec. 18, 2019

Related U.S. Application Data
(62) Division of application No. 15/569,782, filed on Oct. 27, 2017.
(60) Provisional application No. 62/153,524, filed on Apr. 28, 2015.

(51) Int. Cl. C02F 1/78; C01B 13/10; C02F 1/00

(52) U.S. Cl. CPC C02F 1/78; C01B 13/10; C02F 1/002; C02F 1/008; C02F 2209/42; C02F 2209/005; C02F 2201/782; C02F 2303/04; C02F 2209/235; C02F 2201/008

(57) ABSTRACT

A hand portable water purification system including: a cold plasma ozone generator having two spaced apart parallel electrodes for generating ozone; a Venturi injector providing partially ozonated contaminated water; a first and a second reactor tank, each tank in fluid communication with the Venturi injector and the cold plasma generator, wherein the first reactor tank fills with partially ozonated contaminated water provided by the injector, and while being filled, is further ozonated until purified water is obtained and concurrently previously purified water is emptied from the second reactor tank; a low wattage power source for providing power to the system; and a microprocessor/controller for controlling in real time the amount of ozone produced by the generator and for controlling a series of valves. The valves are opened and closed according to a predefined sequence. A method for use of the portable water purification system is also provided herein.

### FIELD OF THE INVENTION

The present invention relates to a portable water purifier system and method.

### BACKGROUND OF THE INVENTION

Although fatal waterborne diseases are no longer a major public health hazard in the US there are still thousands of water-related pathogen-induced cases of illness characterized by vomiting and diarrhea reported annually. This is even truer in Third World countries. An interesting example is the recent legal proceedings initiated by Haitian citizens against the United Nations. The plaintiffs allege that during rescue operations after the Haitian earthquake of 2010, UN personnel spread cholera by disposing their feces in a water source used for drinking resulting in thousands of deaths.

The World Health Organization (WHO) reports that more than two million people die each year due to water related diseases. Fortunately, various disinfection and filtration processes can eliminate the cause of such illness. Biocides such as chlorine and other chemicals may be used to purify contaminated water. However, they have drawbacks such as their effect on the taste of the purified water produced and often undesirable, possibly harmful, residues they leave.

Filtration being a mechanical method may circumvent these drawbacks but generally it is effective only on larger particulates. Small dangerous microbes often are not filterable.

One widely-used method for purifying water contaminated with organic and biological materials is treating it with ozone. This is often done in conjunction with filters designed to remove undesirable particulate matter from the water being purified. Ozone can be produced in many different ways such as by electrolysis, UV irradiation, other photochemical reactions, discharge cells, etc.

Most of the water purification systems using ozone are generally large devices, difficult to carry, to install and to travel with. However, several portable water filtration/purification devices/apparatuses using ozone have been developed.

Current water purifiers, including small portable ozone water purifiers, have a number of well-known deficiencies. These include: slow purification rates; high energy requirements; health risks due to chemicals and ingested purification by-products; complex systems with designs inconvenient for use; and difficulties in verifying results of the purification process. This leads to low confidence in these systems and in the end product they produce. Therefore the design of a new portable water purifying system would be desirable.

It would be advantageous if a new portable, point-of-use water purification system was developed using a low voltage power supply for generating ozone and using inexpensive parts. It would also be advantageous if ozone production were monitored and controlled in real-time. It would be a significant advance if the system and method of its operation provided high purification efficiency capable of producing up to 1,500 liters a day of potable water.

### DEFINITIONS

In what is described herein as “portable” the intention is that a single individual can lift and carry the device. It does not signify “transportable” which will be used only if a transport device, such as a truck or car is needed to carry the device from one location to another. The portable water purifying system will be an autonomous purification system employable at point of use.

“Upstream” as used herein indicates a flow direction opposite to the flow direction indicated by the arrowheads in FIG. 1. “Downstream” as used herein indicates a flow in the direction indicated by the arrowheads in FIG. 1.

The terms “cold plasma generator” and “cold plasma ozone generator” are used interchangeably herein with no distinction intended. Similarly, the term “ozone generator” when used herein is intended to be synonymous with the two cold plasma generator terms discussed in the previous sentence.

“Ozonate”, “ozonated”, “ozonation” and like terms are used herein to denote the treatment of water with ozone, the O₃ allotrope of oxygen.

“Partially ozonated contaminated water” (herein at times denoted for conciseness as POCW) is the ozone and water mixture emitted from the Venturi injector.

### SUMMARY OF THE PRESENT INVENTION

The present invention provides a portable water purification system and a method for its use that can produce high quality water fit for human consumption. The present system is envisioned as typically, but without limiting the size of the invention, weighing about 22 kg with dimensions of about 600 mm by 320 mm by 300 mm. It should be appreciated by persons skilled in the art that the weight and volume of the device can change as long as it does not impact portability.

It is an object of the present invention to provide a fully automated real-time controlled cold plasma generator for producing ozone in a portable water purification system.

The system includes a plurality of reactor tanks in which water is purified by the ozone produced by the cold plasma generator.

It is yet another object to provide a state of the art water purifier in compliance with US EPA and other national guidelines based upon a compact, energy efficient, battery- or photo-voltaic cell operated cold plasma ozone generator.

It is another object of the invention to provide a portable purification system where contaminating bacteria will be decreased by more than 7 log units.

Yet another object of the invention is to provide a water purification system where the filtration elements and ozonation process of the system will not interfere with the essential minerals in the input water, these minerals being preserved during the purification process.

It is a further object of the present invention to provide a low cost portable water purification system.

It is a further object of the invention to provide a low cost portable water purification system for use at the point of sample collection.

There is provided in one aspect of the invention a hand portable water purification system. The system includes a cold plasma ozone generator having two spaced apart parallel electrodes for generating ozone. The generator is configured so that air conveyed to the generator passes perpendicularly through the electrodes. The system also includes a Venturi injector in fluid flow communication with both a contaminated water source and the cold plasma ozone generator; the generator provides ozone to the injector for mixing the ozone with the contaminated water forming partially ozonated contaminated water (POCW). There is a first and a second reactor tank, each tank in fluid communication with the Venturi injector and the cold plasma ozone generator. The first reactor tank fills with partially ozonated contaminated water provided by the injector and while being filled is further ozonated until purified water is obtained. Concurrently with the filling and ozonating operations, previously purified water is emptied from the second reactor tank. The system includes a low wattage power source for providing power to the system wherein the wattage is less than 100 W. Finally the system includes a microprocessor/controller for controlling in real time the amount of ozone produced by the generator. The microprocessor/controller is in electrical communication with the cold plasma ozone generator, the power source, and a series of valves, the valves being opened and closed according to a predefined sequence so that a predefined amount of partially ozonated contaminated water and ozone reach the reactor tanks and purified water is emptied from the reactor tanks.

In another embodiment of the system, the cold plasma ozone generator is constructed so that the spacing between the electrodes, the electrode gap (EG), is equal to or less than 1mm and equal to or more than 200 microns.

In yet another embodiment of the system, one or more of the parallel electrodes is coated with a ceramic dielectric layer on the side of the electrode or electrodes proximate to its electrode pair.

In a further embodiment of the system, the system also includes a pump powered by the low wattage power source for pumping air from the ambient to the cold plasma ozone generator for producing ozone therewith.

In still another embodiment of the system, each of the reactor tanks further includes a first water level sensor to indicate when filling of the reactor tank with partially ozonated contaminated water should be stopped and a second water level sensor to indicate when emptying of the purified water from the reactor tank should be ended. The sensors are in electrical communication with the microprocessor/controller.

In another embodiment of the system, the system includes first and second ozone sensors in electrical communication with the microprocessor/controller wherein the first ozone sensor is associated with the first reactor tank and the second ozone sensor is associated with the second reactor tank. Each sensor is positioned externally to its respective reactor tank to measure the concentration of ozone discharged from its respective reactor tank.

In yet another embodiment of the system, the system further includes first and second ozone sensors in electrical communication with the microprocessor/controller. The first ozone sensor is associated with the first reactor tank and the second sensor is associated with the second reactor tank. Each sensor is positioned inside its respective reactor tank to measure the concentration of ozone in the volume above a maximum upper water level in its respective reactor tank.

In still another embodiment of the system, the low wattage power source for the system is chosen from one or more batteries or one or more photovoltaic cells having a maximum wattage of 50W.

In yet another embodiment of the system, the cold plasma ozone generator requires a power wattage of from about 1 W to about 10 W.

In another embodiment of the system, the system includes a first carbon block filter positioned to filter the contaminated water prior to passing the water through the Venturi injector and a second carbon block filter positioned in the system downstream from the first and second reactor tanks.

In still another embodiment of the system, the system includes one or more carbon block filters to filter the contaminated water and further containing an amperage sensor for monitoring the amperage used by a water pump thereby monitoring the efficiency of operation of the one or more filters.

In a further embodiment of the system, the first and second reactor tanks are selected from a group comprising at least three reactor tanks.

In another aspect of the present invention there is provided a method for purifying water with a portable purification system. The method includes the steps of:
activating a pump for providing air from the ambient atmosphere to a cold plasma ozone generator for generating ozone and activating a water pump for providing water from a contaminated water source to a Venturi injector;
providing ozone generated in the cold plasma ozone generator to the contaminated water passing through the Venturi injector, thereby producing partially ozonated contaminated water;
conveying partially ozonated contaminated water from the Venturi injector to a first reactor tank, wherein the water enters and fills the tank and, while filling the tank, the water therein is concurrently further ozonated until substantially all organic and biological material is oxidized;
except after the initial performance of the step of conveying described immediately above perform the following step: emptying a second reactor tank of its purified water contents while filling the first reactor tank with the partially ozonated contaminated water and then further ozonating the contaminated water,
conveying partially ozonated contaminated water from the Venturi injector to the second reactor tank, wherein the water enters and fills the tank and, while filling the tank, the water therein is concurrently further ozonated until substantially all organic and biological material is oxidized;
emptying the first reactor tank of its fully purified water contents while filling the second reactor tank with the partially ozonated contaminated water and then further ozonating the contaminated water;
repeating all of the steps from the first step of conveying to the second step of emptying as many times as required to obtain the desired quantity of purified water.

In another embodiment of the method, the first step of conveying further includes a step of measuring the ozone emitted from the first reactor tank to determine when oxidation of organic and biological matter is substantially complete and when the purified water may be emptied from the first reactor tank.

In still another embodiment of the method, the second step of conveying includes a step of measuring the ozone emitted from the second reactor tank to determine when oxidation of organic and biological matter is substantially complete and when the purified water may be emptied from the second reactor tank.

In a further embodiment of the method, the method includes a step of activating a second water pump downstream from the reactor tanks to assist in emptying of the water from the reactor tanks.

In yet another embodiment of the method, the method includes a step of filtering the water with a second carbon block filter positioned downstream of a second water pump, the second pump being positioned downstream from the reactor tanks.

In a further embodiment of the method, the method includes a step of measuring the ozone emitted from a reactor tank with an ozone sensor positioned in a bypass configuration.

In still another embodiment of the method, the cold plasma ozone generator operates without arcing and reaches a maximum temperature of 40° C. under full operating conditions.

In a yet another embodiment of the method, the cold plasma ozone generator operates without arcing and reaches a maximum temperature of 30° C. under normal ozone generation conditions.

In another embodiment of the method, the method includes a step of closing a valve to prevent further partially ozonated contaminated water from entering a reactor tank when the reactor tank is determined to be full.

In yet another embodiment of the method, the generator is constructed with parallel electrodes and configured so that the air flow passes through the ozone generator substantially perpendicular to its electrodes.

In still another embodiment of the method, the method further includes a step of passing ozone through the system to disinfect the system prior to activating the system to produce purified water.

In another aspect of the present invention, there is provided a hand portable water purification system. The system includes a cold plasma ozone generator having two spaced apart parallel electrodes for generating ozone, the generator configured so that air conveyed to the generator passes perpendicularly through the electrodes. The system also includes a Venturi injector in fluid flow communication with both a contaminated water source and the cold plasma ozone generator, the generator providing ozone for mixing in the injector with the contaminated water forming partially ozonated contaminated water (POCW). The system includes a plurality of reactor tanks wherein each reactor tank is in fluid communication with the Venturi injector and the cold plasma generator. One of the reactor tanks fills with partially ozonated contaminated water provided by the injector, and while being filled, is further ozonated until purified water is obtained. Concurrently previously purified water is emptied from another reactor tank. The system uses a low wattage power source for providing power to the system wherein the wattage is less than 100 W. Finally, the system includes a microprocessor/controller for controlling in real time the amount of ozone produced by the generator. The microprocessor/controller is in electrical communication with the cold plasma ozone generator. The power source, and a series of valves, the valves being opened and closed according to a predefined sequence so that a predefined amount of partially ozonated contaminated water and ozone reach the reactor tanks and purified water is emptied from the reactor tanks.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only. They are presented so as to provide what is believed to be the most useful and readily understood description of the principles and conceptual aspects of the invention. In this regard, no attempt is made to show structural details of the invention in greater detail than is necessary for a fundamental understanding of the invention. The description taken with the drawings make apparent to those skilled in the art how the several forms of the invention may be embodied in practice.

In the drawings:

FIG. 1 is a schematic diagram of the water purification system of the present invention;

FIG. 2A is a schematic diagram of a cold plasma ozone generator used in the system shown in FIG. 1;

FIGS. 2B through 2F show circuits for use as drivers of the cold plasma ozone generator shown in FIG. 2A;

FIG. 3 is a block diagram of the processing and control electronics of the portable purification system of the present invention; and

FIG. 4 is a flow chart of a method for purifying water with a portable purification system of the present invention.

Similar elements in the Figures are numbered with similar reference numerals.

### DESCRIPTION OF PREFERRED EMBODIMENTS

The present invention provides a portable water purification system and a method for its use. The invention provides a fully automated real-time controlled system including a cold plasma ozone generator for producing ozone. The system of the present invention uses a compact energy efficient battery-operated or photovoltaic cell-operated power source.

The system also includes a plurality of reactor tanks in which water is purified by the ozone produced by the cold plasma ozone generator.

The ozone sensors of the system monitor and track in real-time organic material and microbial levels in the water being purified. The ozone sensors analyze the ozone/air mixture emitted from the reactor tanks.

It is envisioned that the portable water purification system will provide potable drinking water in remote areas and in emergency situations. It is also envisioned that the system will eliminate dependence on the local water distribution network for the supply of pure safe drinking water to scattered populations. Similarly, the system can be used to produce microbiologically safe drinking water for use by travelers, by trekkers, by military, security, and emergency forces, and by yachtsman and other seamen of small vessels.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It is to be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

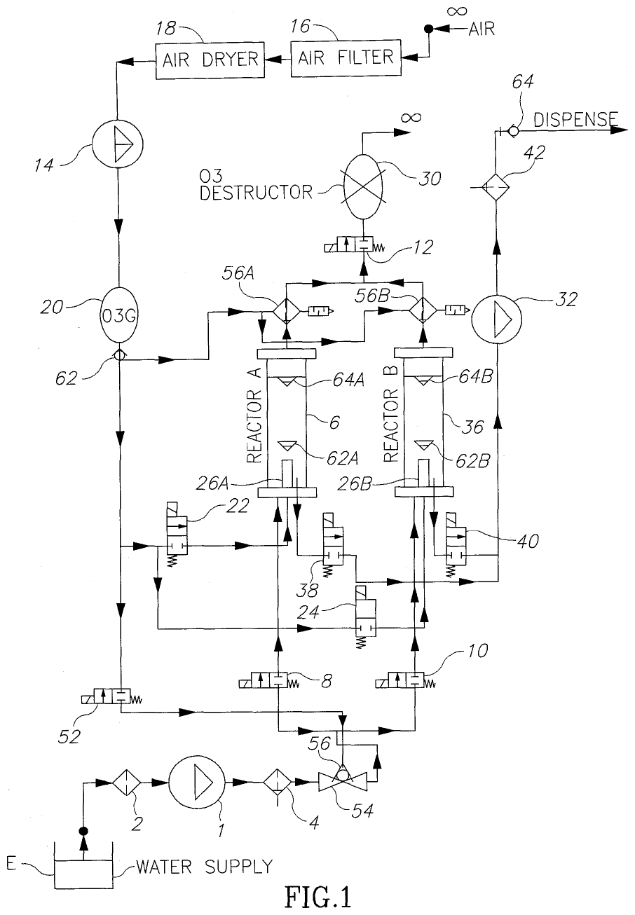

Reference is now made to FIG. 1 where a schematic diagram of the system of the present invention is shown. In addition to instantiating the elements of the system, the Figure will also be used to describe the method of use of the system.

The filling and purifying of water in reactor tank A (6) of FIG. 1 and the substantially concurrent emptying of reactor tank B (36) of FIG. 1 is herein designated as stage A of the method. The filling and purifying of water in reactor tank B (36) and the substantially concurrent emptying of reactor tank A (6) is herein designated as stage B of the method. Thus one reactor tank in each stage operates in a filling/purifying phase while the second reactor tank operates concurrently in an emptying phase. The filling/purifying phase of reactor tank A takes place in parallel with emptying phase of reactor tank B in stage A of the method. Similarly, the filling/purifying phase of reactor tank B takes place substantially concurrently with emptying phase of reactor tank A in stage B of the method. Filling and ozonating in the filling/purifying phase in stage A and B occur at the same time in reactor tanks A and B, respectively.

Elements having suffixes with the letter A are associated with the operation of reactor tank A (6); parts having suffixes with the letter B are associated with the operation of reactor tank B (36). All elements with a B suffix operate exactly as their equivalently numbered element with an A suffix but with reactor tank B instead of with reactor tank A.

In the discussion below, reactor tanks A and B may be indicated herein as reactor tanks 6 and 36 respectively or reactor tanks A (6) and B (36) respectively without any distinction intended.

The reactor tanks are typically made from stainless steel but it should readily be appreciated that other ozone-resistant materials can be used. The reactor tank seals are made of Teflon® or other ozone-resistant materials as are the valves and conduits/pipes/tubes of the system. The terms “conduit”, “pipes”, and “tubes” may be used interchangeably herein without intent at distinguishing between them. The valves used in the system being described are typically solenoid valves, unless another type of valve is specifically indicated.

In stage A, water pump 1 draws contaminated water from a contaminated water source E located external to the system. The water is passed through a crude filter 2 positioned upstream of water pump 1 and then through a carbon block filter 4 positioned downstream of water pump 1. Crude filter 2 is typically, but without intending to limit the invention, a double mesh filter which traps gross particulates while active carbon filter 4 removes material particulates greater than 5 microns and removes chlorine, if present, from the contaminated water.

The water is then fed to, and accelerated through, a Venturi injector 54. As the water passes through Venturi injector 54 it is partially ozonated. The water enters the Venturi injector at a pressure, typically, but without limiting the invention, of about 2 pounds per square foot provided by water pump 1 and exits at atmospheric pressure. This produces suction of the ozone approaching the Venturi injector and assists in mixing the ozone with the water. This ozone and water mixture emitted from the injector will be denoted herein as “partially ozonated contaminated water”. Partially ozonating water at this point in the system reduces purification time in reactor tanks A and B as described below.

A Venturi injector 54 is used because its ozone mass transport coefficient is 80%, while the ozone mass transport coefficient of diffusers 26A and 26B (discussed below) in reactor tanks A and B, 6 and 36, respectively (also discussed below) is only 15%. It has been found that use of the Venturi injector in concert with diffusers 26A and 26B cuts water purification time in the reactor tanks by about a half.

The filtered partially ozonated water is then led from Venturi injector 54, past check valve 56 positioned adjacent to Venturi injector 54, to fill first reactor tank A. While filling first reactor tank A in stage A of the process, water valve 8 is kept open and water valve 10 leading to reactor tank B is kept closed. During the filling of either reactor tank A or B with water, valve 12 is kept open so that air and ozone can be driven from the reactor tank being filled. This keeps the system at all times at atmospheric pressure.

As the contaminated water is pumped by water pump 1 from source E into the system, or even prior to operation of water pump 1, air pump 14 is activated and draws air from the atmosphere into the system. The air from the atmosphere is drawn past an air filter 16 and an air dryer 18 positioned upstream from an ozone generator 20. In the present system a cold plasma generator 20 is used to provide ozone.

Cold plasma generator 20 is constructed and operated under conditions so that there is little loss of energy in the form of heat as is the case in other plasma and ozone generators. Arcing in the generator is minimized, or eliminated entirely, also keeping energy losses to a minimum.

Because of the system's small size, small power sources (not shown) are used such as batteries or solar/photo-voltaic cells. Conservation of the available power from these sources is essential and the cold plasma generator helps accomplish this as noted above by minimizing arcing and heat loses. The system of the present invention uses a low wattage power source (equal to or less than 100 W, typically 50 W) and the system consumes little power. Ozone may be generated at just 3 W for a 0.25 wt/wt % (% ozone/air by weight) yield. More typically, the cold plasma ozone generator requires power with a wattage of 5-10 W. It should be noted that other purification systems generally require 500 W power sources. This must be supplied by much larger sources and not by relatively small, compact batteries or photovoltaic cells.

From generator 20, ozone produced therein passes check valve 62 and open ozone valve 52. The ozone then passes check valve 56 into Venturi injector 54 where partial ozonation occurs as discussed above. The ozone also passes through open ozone valve 22 into reactor tank A which during stage A of the method is being filled with the partially ozonated water arriving from Venturi injector 54. While reactor tank A is filling, the water is simultaneously being ozonated in reactor tank A by the ozone arriving directly from generator 20 via valve 22. Ozonation continues until essentially all of the organic material in the contaminated water from water supply E has been oxidized.

It should be noted that because there is ozonation of the incoming water as it fills the reactor tank, the water is purified faster than when the step of filling the reactor tank is done separately from the step of ozonation. More surprisingly, it has been found that the concurrent filling and ozonation produces water of higher purity than when these operations are done separately.

Ozone valve 52 is closed after reactor tank A has been filled completely. Since reactor tank A is completely filled and being ozonated with ozone arriving directly from ozone generator 20, additional water from Venturi injector 54 is no longer needed. Therefore, no ozone needs to be passed through valve 52 to Venturi injector 54. While water is filling and being ozonated in reactor tank A, ozone valve 24 in fluid communication with reactor tank B remains closed so that no ozone enters reactor tank B. Similarly, water valve 10 remains closed so no partially ozonated water enters reactor tank B from Venturi injector 54 in stage A of the process.

When ozone enters reactor tank A, it passes through diffusor 62A which assists in diffusing the ozone into the water present in reactor tank A.

As water enters reactor tank A, it first passes lower water level sensor 62A and then upper water level sensor 64A. Both of these float water level sensors are in electrical communication with a controller (not shown). When water reaches upper water level sensor 64A, the sensor signals the controller which shuts water valve 8 stopping entry of additional partially ozonated water from Venturi injector 54 into reactor tank A.

When ozone sensor 56A (described below) signals to the controller that the water in the filled reactor tank has completely oxidized the organic and biological contamination in reactor tank A, the controller signals egress water valve 38 to open. The controller activates water pump 32 so that it assists in drawing off the purified water from reactor tank A through valve 38. Reactor tank A is emptied until the level of lower water level sensor 62A is reached. It is important that the water level does not drop below the level of water sensor 62A since that could lead to drying out of water pump 1, typically a gear pump, an undesirable consequence.

It should be noted that the height and diameter of reactor tanks A and B are chosen to optimize the water purification rate. In the system the length of the pipes, also at times herein termed “conduits” or “tubes”, are minimized to prevent undesirable dead volume. This reduction in the dead volume of the system prevents unwanted bacterial build up. The valves therefore are situated as close as possible to reactor tanks A and B. The water and ozone valves closest to the reactor tanks, for tank A valves 22, 8, and 38, and for tank B valves 24, 10 and 40, are attached to the flanges of the reactor tanks, thereby reducing the volume required to contain the system.

For the same reasons as described immediately above, the pumps are positioned as close as possible to the valves. The distance between the pump and valves is typically, but without intending to limit the invention, equal to or less than 5 cm.

In stage A of the process, ozone sensor 56A determines when ozonation is complete that is when oxidation of the organic and biological materials in reactor tank A is complete. When sensor 56A indicates that the ozone concentration in reactor tank A is lower than that initially supplied by ozone generator 20 it is assumed that the organic material and pathogens in the water are still being oxidized in reactor tank A. After all the organic material has been oxidized by the ozone to carbon dioxide and water (as well as to small amounts of other oxides such as nitrogen oxides, sulfur oxides, etc.), the concentration of ozone in reactor tank A increases markedly to a value substantially equal to the concentration initially supplied by ozone generator 20. Ozone sensor 56A detects this increase and relays this data to the controller, which in turn then shuts ozone valve 22 and opens egress water valve 38.

In order to be able to use cheaper, less sensitive, ozone sensors that is ones that have a detection capability of X ppm and not of Y ppm where X is greater than Y, a sensor by-pass configuration is used as shown in FIG. 1. The bypass is the ozone conduit from check valve 62 to ozone sensor 56A.

After ozone has completely oxidized all the organic matter in reactor tank A as determined by sensor 56A, valve 22 is closed so that ozone is not provided by ozone generator 20 to reactor tank A (6). When ozonation has been completed in reactor tank A as indicated by ozone sensor 56A, the sensor communicates this fact to the controller which instructs valve 38 to open so that reactor tank A may empty.

At the same time as reactor tank A empties through valve 38 with valves 22 and 8 shut, the controller opens valves 10 and 24 leading to reactor tank B. Reactor tank B then fills with partially ozonated water brought from Venturi injector 54 through valve 10 to reactor tank B. Ozone passes through open ozone valve 24 allowing ozone from ozone generator 20 to simultaneously ozonate the water while it is entering and filling reactor tank B. The ozone entering tank B first passes through diffuser 26B and diffuses through the partially ozonated water arriving from Venturi injector 54. This is the beginning of stage B of the process.

Note again that as water is filling reactor tank B, it is simultaneously being ozonated. This reduces the residence time required for complete ozonation and water purification as contrasted when ozonation begins only after the entire reactor tank is first filled. Also note that as water is entering and being ozonated in tank B, the purified water in tank A is being emptied.

Reactor tank B contains water level sensors 62B and 64B which operate exactly as water level sensors 62A and 64A of reactor tank A described above. Similarly, ozone sensor 56B associated with reactor tank B operates and uses a bypass connection just as ozone sensor 56A associated with reactor tank A described above. As noted above, the purified water of reactor tank A or reactor tank B is drawn off under the suction provided by water pump 32. Pump 32 is activated by the controller when ozone sensor 56A in stage A or ozone sensor 56B in stage B shows a rapid increase in ozone concentration. This indicates that oxidation of the organic contaminants in reactor tanks A or B, respectively, has been completed. The water emptying from tank A flows past water valve 38, now open, in the direction of, and past, pump 32. The purified water is then filtered by a second carbon block filter 42 positioned downstream from pump 32. After filtration, the purified water moves past a check valve 64 to a vessel (not shown) external to the system. The vessel catches and/or stores the purified water produced in reactor tank A in stage A and reactor tank B in stage B of the process.

Filter 42 is a carbon block filter with filtering ability of 1 micron. It filters heavy metals, residual ozone, cystic and bacterial residues such as, but without any intent at limiting the operation and structure of the filter, Giardia and Cryptospradium.

Carbon filters 4 and 42 are monitored to determine when filter replacement is needed. One method of tracking any deterioration in filtering efficiency of filters 4 and 42 is to track the amperage required by water pumps 1 and 32. If amperage increases above a preset amount then the filter is at least partially blocked and a replacement filter is required. Without intending to limit the invention, monitoring may be effected using a WPI amperage sensor positioned in the controller. The controller shuts down the system when the filters are blocked and /or filtering efficiency has decreased.

While reactor tank A is emptying as described above, reactor tank B is filling with partially ozonated water from Venturi injector 54. When filling reactor tank B, the partially ozonated water is further ozonated with ozone arriving directly from ozone generator 20 through valve 24. The filling and ozonating process of reactor tank B are timed to coincide with the emptying of the purified water in reactor tank A from stage A of the process. Therefore the filling/ozonating /purifying phase of water in one reactor tank is timed to coincide with the drawing off of purified water from the second reactor tank to an external catch/storage vessel.

The staggered operation of reactor tanks A and B may be repeated as many times as necessary.

The ozone/air mixture that exits reactor tank A and reactor tank B passes ozone sensor 56A and 56B, respectively, and arrives at ozone destructor 30. The ozone emitted from the reactor tanks is destroyed in ozone destructor 30 and emitted into the atmosphere. Any of several different ozone destructors may be used. These may include, but are not limited to a metal catalyst, UV irradiation, or a thermal-based destructor.

A valve 12 is positioned upstream of ozone destructor 30 and downstream of, zone sensors 56A and 56B. Valve 12 is operative to close and prevent water from entering ozone destructor 30 when the system is inadvertently tilted.

In some embodiments, an optional additional sensor may be added downstream of ozone destructor 30 to ensure that the concentration of ozone being released from destructor 30 without being decomposed is within environmental limits. If the ozone levels detected are higher than a predetermined level, the system's controller may shut down operation of the system. Alternatively, they may A. redirect the air/ozone mixture through a conduit (not shown) to the ozone destructor 30 for an additional destruction/decomposition step; and/or B. reduce the level of ozone supplied by generator 20 passing through reactor tanks A and B by signaling the controller to: i. modify the settings of the cold plasma generator 20 so as to reduce the concentration of the ozone being generated and being circulated through the system; and/or ii. depending on the type of ozone destructor 30 being used, increase its operational efficiency.

In another embodiment of the system, at least one water purity detector may be positioned upstream or downstream of pump 32. In another embodiment the detector may be positioned downstream of carbon filter 42. In yet another alternative, if the detector indicates that the purified water does not meet a predetermined standard of purity, the electronics of the system may direct recycling of the water for additional purification. A recycle conduit controlled by a recycle valve (both not shown in the Figure) would be positioned downstream of the water purity detector (also not shown). The recycling valve would be opened by the controller based on the reading of the water purity detector. The water would be sent for additional ozonation to either reactor tank A or B via the fluid recycling conduit (not shown) as described above.

In another embodiment of the invention, ozone sensor 56A would be positioned within reactor tank A to monitor the ozone in the tank. If the ozone levels there are too high or too low, the sensor signals the controller that a correction of the amount of ozone being supplied by the ozone generator 20 is necessary. This could be affected, for example, by adjusting the voltage on the capacitor plates of the ozone generator or adjusting the rate of air being pumped from the atmosphere to generator 20 by air pump 14.

It should be remembered that the use of two reactor tanks should be considered as exemplary only. In some embodiments there may be more than two reactor tanks. In these other embodiments, the use of the reactor tanks is still staggered as it is with reactor tanks A and B described above, with appropriate modification as necessary.

It should be noted that prior to use of the system, the system may be self-cleaned by circulating ozone produced by generator 20 through the pipes/conduits/valves/ reactor tanks of the system.

Valves V1-V8 are two-way, two-position solenoid valves obtainable from many commercial suppliers such as SMC Corp of America, Noblesville, Ind. and AirTac of Taipei, Taiwan. One-way check valves may be ball valves or their functional equivalents obtainable from many commercial suppliers such as SMC Corp of America.

Venturi injector 54 is typically a Kynar® polyvinylidene fluoride (PVDF) Venturi injector obtainable from many commercial suppliers such as Mazzeri Injector Company, of Bakersfield, Calif.

Ozone sensors 56A and 56B having a sensitivity of 1-10000 ppm are obtainable from many commercial suppliers such as Henan Hanwei Electronics Co of Henan, China. A typical ozone sensor which may be used is MQ131 Semiconductor Sensor for Ozone produced by Henan Hanwei.

Water level sensors 26A, 26B, 64A and 64B are float sensors obtainable from many commercial suppliers such as Dwyer Instruments Inc. (Michigan City Ind.). Dwyer' s series F6 sensors are one of many sensors that may be used.

Ozone destructor 30 may use any of several different methods to destroy the excess ozone such as a catalyzer method. An ozone destructor based on the use of a catalyzer may be obtainable from any of many commercial suppliers, such as Ozone Solutions Inc. (Hull, Iowa).

Air pumps such as membrane pumps are obtainable from any of many commercial suppliers such as Gardner Denver Thomas of Sheboygan, Wis. Water pumps such as gear pumps are obtainable from any of many commercial suppliers such as Fluid-o-Tech USA Inc. of Concord Calif.

Ozone generators are known in the art. Particular ozone generators that can be configured to be used with the mechanical, pneumatic, hydraulic and control systems of the water purifier described herein include Clear Water Tech's Microzone 300 model manufactured by Clear Water Tech Inc., of San Luis Obispo, Calif. and Del Ozone's Eclipse 1 model produced by Del Ozone of San Luis Obispo, Calif.

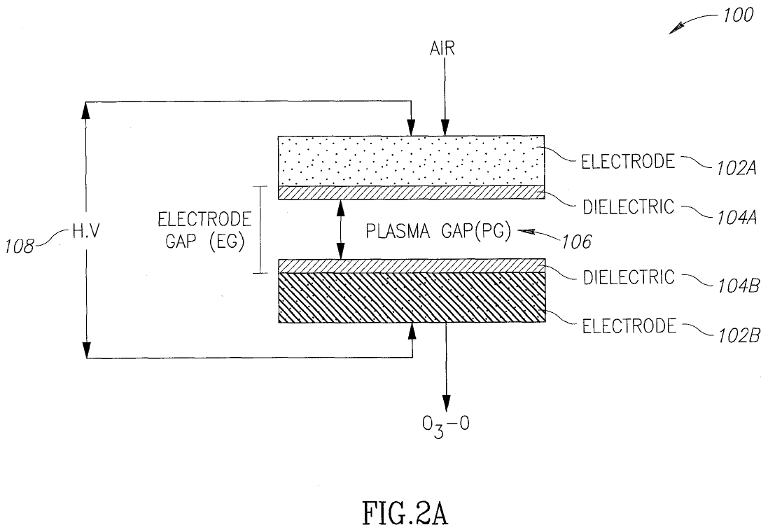

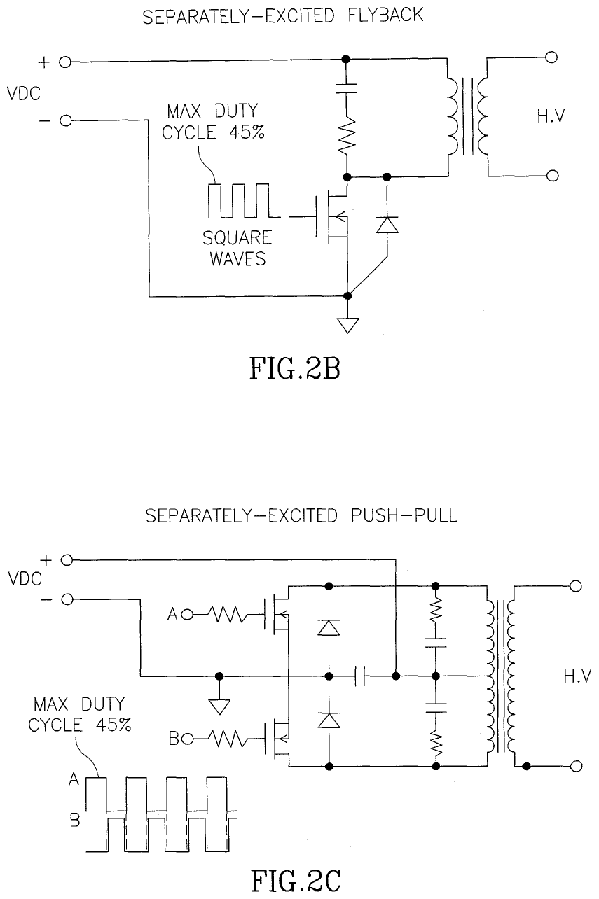

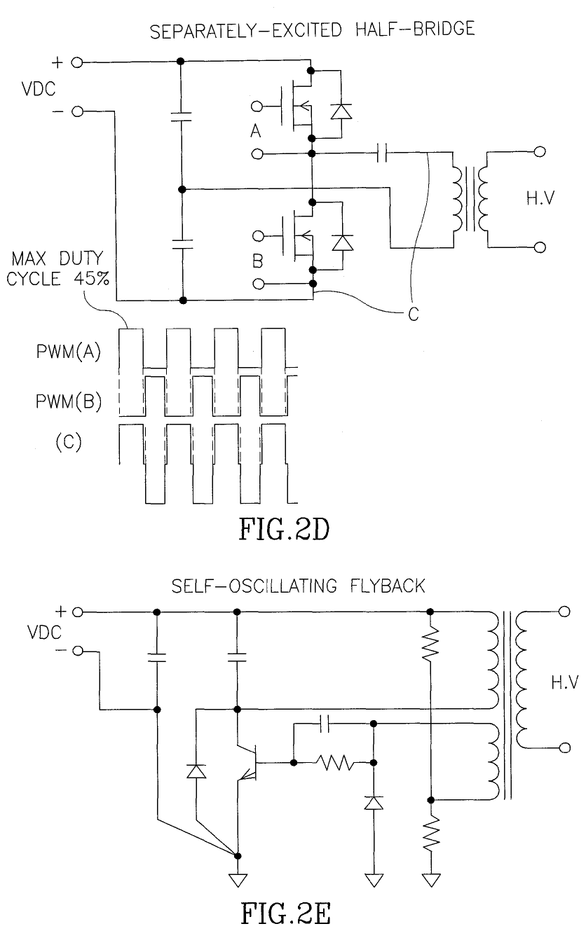

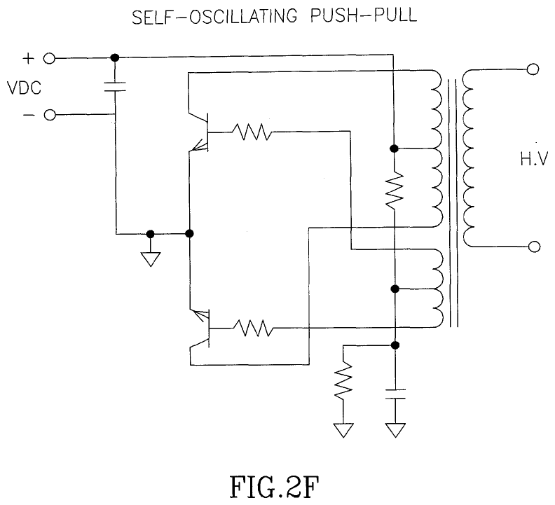

Reference is now made to FIG. 2A where an ozone generator used in the present invention, here a cold plasma generator 100, is shown. In the cold plasma method, oxygen or air, herein the latter, is exposed to a plasma created by dielectric barrier discharge.

For purposes of the discussion herein, the terms “ozone generator”, “cold plasma generator” or “cold plasma ozone generator” will be used interchangeably without intending to distinguish between them. They all refer to cold plasma devices.

Cold plasma generator 100 of FIG. 2A provides a cold plasma which generates ozone from air flowing between electrodes 102A and 102B. In FIG. 2A, each of metal electrodes 102A and 102B is coated with a dielectric ceramic material layer 104A, 104B allowing greater charge accumulation on the electrode surface for a given voltage. The thickness of the ceramic material layer should be great enough to prevent breakdown voltage and resulting arcing. It should be noted that in other embodiments of the generator only one electrode may be coated with a dielectric.

The distance between metal electrodes is herein called the “electrode gap” (EG in FIG. 2A). The distance between dielectrics or in the case when only one electrode is coated with a dielectric ceramic, the distance between the dielectric and the other uncoated metal electrode is herein denoted as the “plasma gap” (PG in FIG. 2A).

As the distance between metal electrodes 102A and 102B decreases, the ozone concentration produced increases. A typical electrode gap that can be used in the present invention is about 1 mm±0.01 mm. A more preferred spacing for the electrode gap is less than 200 microns. In the present invention, the electrodes are generally not grounded. Because of the small electrode gap, voltage is low as are energy losses.

Cold plasma generator 100 in FIG. 2A has a compact size and a low weight therefore requiring low electrical energy consumption. The ozone generator provides for stable ozone production over long time periods and the system can use small power sources (less than 50W) such as batteries and photovoltaic cells. Cold plasma generator 100 produces an uniform plasma over an extended time with the ozone generated continuously monitored and controlled in real-time.

The electrodes of the cold plasma ozone generator 100 may be made of stainless steel although it should readily be appreciated by persons skilled in the art that other metals can be used to fabricate the electrodes as long as they are ozone resistant. The thin film dielectric has a high epsilon to h ratio, where h is the thickness of the dielectric and epsilon the selected ceramic's dielectric constant. The ceramic chosen has a dielectric constant which enables minimizing the distance between the electrodes; this in turn minimizes plasma voltage while maximizing the ozone concentration generated.

The air flow in the plasma gap is uniform. As can be seen in FIG. 2A, the air flow is perpendicular to the electrodes. The electrodes have holes positioned therein which allow such perpendicular flow. This is different from the more conventional air flow pattern in cold plasma generators, where the flow is generally parallel to, and between the, electrode plates.

The efficiency of the cold plasma ozone generator of the present invention is equal to or greater than 90%. Less than 10% of the energy ends up as heat. Because only small amounts of heat are produced, no cooling apparatus is required. The heat produced by the cold plasma cell typically reaches only 30° C. At full power, the temperature may reach 40° C. Ozone generator 100 can be controlled in real-time so as to produce a stable ozone concentration over at least 24 hours of non-stop operation.

The ozone concentration generated is, among other features, to a degree a function of the ceramic dielectric layer having a given dielectric constant and a layer of a given thickness. This can be considered as passive control of the ozone concentration produced. The ozone concentration generated may also be actively controlled in real-time by choice of frequency or voltage being supplied to the generator and decreasing or increasing air flow.

The drivers used with cold plasma generator 100 may have any of the following topologies shown in FIGS. 2B through 2F, these topologies being known to persons skilled in the art. The topologies of these drivers include flyback, push-pull, and half-bridge drivers. The drivers are connected at their HV outlets to the corresponding HV inlets 108 of cold plasma ozone generator 100 in FIG. 2A

Of the topologies shown in FIGS. 2B-2F, the half bridge arrangement provides more power than the push-pull system, which in turn provides more power than the flyback system. However, the latter configuration is the least expensive of the three.

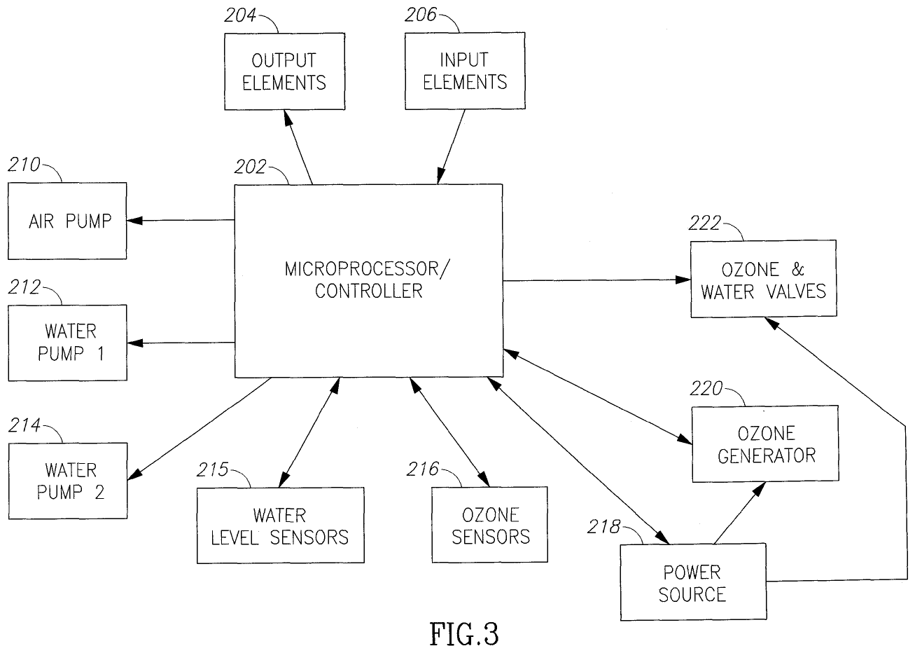

Reference is now made to FIG. 3 where a schematic view of the processing and control electronics of the portable water purifier of the present invention is shown. The electronics are configured to allow for continuous real-time automatic process validation, monitoring and control of the various parts of the system that is the mechanical, electrical, hydraulic and pneumatic parts of the system.

A microprocessor/controller 202 is in electronic communication with input elements 206 and output elements 204. Typical input elements 206 may include, but are not limited to, touch pads and a keyboard. Typical output elements 204 used in the system include, but are not limited to, displays and other types of communication modules. These output elements and input elements are typically, but again without intending to be limiting, positioned on the outside face of a container containing the entire system described herein above. The container may be formed in the shape of a suitcase, but it should be appreciated that other container shapes may also be used.

The following discusses specific aspects of the real-time automatic process validation in the system of the present invention.

Microprocessor/controller 202 is preset to a desired ozone concentration prior to activating the system of the present invention. Predetermined input values for the system parameters are inputted to the microprocessor/controller 202 so that the ozone concentration supplied to the reaction tanks and remaining dissolved in the water can be measured.

Microprocessor/controller 202 is in continuous electronic communication with ozone sensors 216 (56A and 56B in FIG. 1), water level sensors 215 (62A, 62B, 64A, 64B in FIG. 1) and ozone generator 220 (20 in FIG. 1). From water level sensors 215 and ozone sensors 216, microprocessor/controller 202 receives information inter alia regarding the height of the water level in the reactor tanks, and the concentration of ozone emitted from the reactor tanks. These sensors indicate when and which water and ozone valves (not shown in FIG. 3) are to be opened or shut by the microprocessor/controller 202. The opening and closing of valves follow a pre-defined schedule and order stored in microprocessor/controller 202. This order is essentially as discussed above when describing the system.

Microprocessor/controller 202 continuously receives information from the cold plasma ozone generator 220 (20 in FIG. 1) during its use. The information received includes inter alia air flow rate, air relative humidity, voltage across the electrodes of the ozone generator, frequency of the alternating current, and pulse width modulation used. Some of the information pertaining to cold plasma ozone generator 220, such as the electrical characteristics of the dielectric, the thickness of the dielectric layer and the distance of the electrode gap, is inputted into the microprocessor/controller prior to activating the cold plasma ozone generator. These latter inputs are substantially constant for a given cold plasma ozone generator configuration and remain substantially unchanged during its operation.

Other information, such as the actual ozone concentration being generated and the time required to purify the water filling a reactor tank vary during use and also from use to use.

Values of these variables are tracked by using ozone sensors 216 which communicate the data to microprocessor/controller 202 in real time. Then, again in real time, the microprocessor/controller calculates and resets inter alia the voltage, the air flow rate, and/or frequency of the electrical input being used by cold plasma generator 220. The new reset values are communicated by microprocessor/controller 202 to cold plasma ozone generator 220 by changing operational parameters of the ozone generator such as air flow and current. These changes are required so that A. the ozone concentration that is generated is the same as that calculated by the microprocessor/controller, B. the power consumption required to provide item A is being supplied to the cold plasma generator; and C. changes needed to maintain a stable heat/ozone yield ratio for the inputted energy are made.

Microprocessor/controller 202 is in electronic communication with air pump 210 and water pump 212. When the user employs an input element 206 to signal microprocessor/controller 202 to begin the purification process, air pump 210 and water pump 212 are activated providing air to ozone generator 220 and water to Venturi injector 54 (FIG. 1) and reactor tanks A and B.

Ozone sensors 216 and upper and lower water level sensors 215 are in electronic communication with microprocessor/controller 202.

Upper and lower level water sensors 215 are positioned in reactor tank A at the levels where the tanks are considered full and empty respectively. Filling reactor tank A begins when microprocessor/controller 202 signals ingress water valve 8 (FIG. 1) to open and to allow partially ozonated water from the Venturi injector 54 (FIG. 1) into reactor tank A. When water has reached upper water level sensor 64A (FIG. 1) in reactor tank A, sensor 64A provides signals to microprocessor/controller 202 indicating that tank A is full. When tank A is full, microprocessor/controller 202 shuts ingress water valve 8 (FIG. 1) to reactor tank A. It also shuts ozone valve 52 (FIG. 1) stopping ozone from reaching Venturi injector 54 (FIG. 1).

When ozone sensor 216 (56A; FIG. 1) in fluid flow communication with tank A detects a significant rise in ozone concentration indicating that oxidation of the organic matter and pathogens in the reactor tank has been completed, microprocessor/controller 202 receives an appropriate signal from the ozone sensor. Microprocessor/controller 202 then instructs ingress ozone valve 22 (FIG. 1) to close.

Emptying tank A then begins with egress water valve 38 (FIG. 1) associated with reactor tank A being instructed by microprocessor/controller 202 to open so that the purified water may empty from tank A. When the water level reaches lower water level sensor 62A (FIG. 1) positioned at a level in tank A below which the water level must not fall, a signal is sent to microprocessor/controller 202 from the lower water level sensor 215 (62A in FIG. 1). Microprocessor/controller 202 then shuts egress water valve (38 in FIG. 1) of tank A.

After water has been satisfactorily purified in either reactor tank A or B (the latter discussed below), microprocessor/controller 202 activates water pump element 214 (pump element 32 in FIG. 1) to draw off the purified water exiting from tanks A and B so that it may exit the system.

Based on what has been discussed previously, it should be remembered that the filling/ozonating and emptying stages of water purification in reactor tank B are controlled by the microprocessor/controller, and monitored by sensors in the same manner as described immediately above for reactor tank A. As noted above, there are separate, but analogous operating valves, similar upper and lower water level sensors and a similar ozone sensor for reactor tank B. Their operation in conjunction with microprocessor/controller 202 is the same as discussed above in conjunction with reactor tank A.

The staggered water purification cycles first using reactor tank A for water purification (stage A of the process) and then using reactor tank B for water purification (stage B of the process) can in theory continue for an unlimited number of cycles. There are, however, practical limitations to the number of cycles that the system can run. For example, at least because of the size and type of power source employed and the filtering capacity of the carbon filters the number of cycles is not unlimited. Additionally, input from the user using an input element as discussed above may truncate the number of purification cycles at the user's discretion.

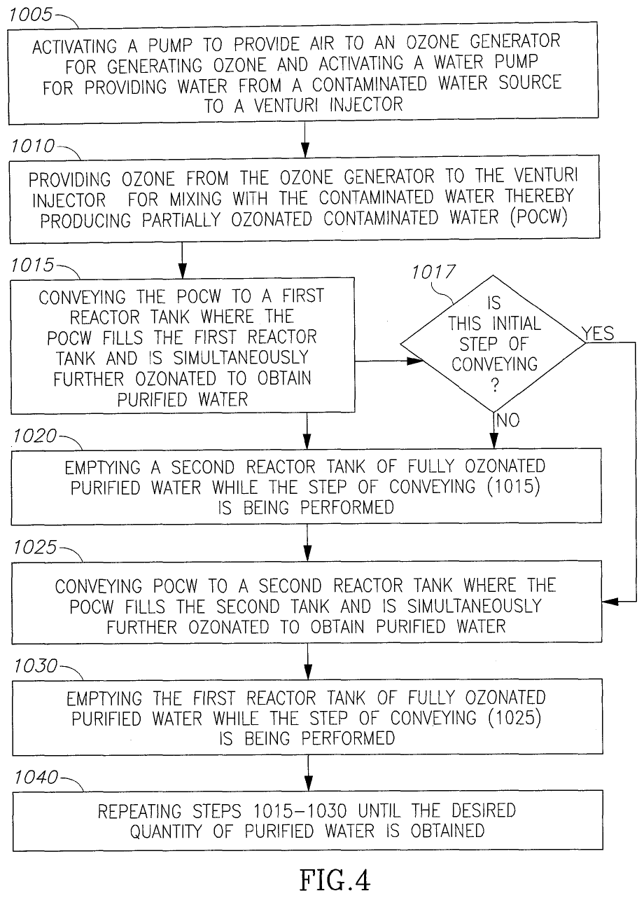

A method for purifying water using the systems discussed above is shown in the flow chart of FIG. 4 to which reference is now made. The Figure corresponds to the following description of the method:
activating a pump for providing air from the ambient atmosphere to a cold plasma ozone generator for generating ozone and activating a water pump for providing water from a contaminated water source to a Venturi injector; (Step 1005)
providing ozone generated in the cold plasma ozone generator to the contaminated water passing through the Venturi injector, thereby producing partially ozonated contaminated water; (Step 1010)
conveying partially ozonated contaminated water from the Venturi injector to a first reactor tank, wherein the water enters and fills the tank and, while filling the tank, the water therein is concurrently ozonated; (Step 1015)
except after the initial performance of the step of conveying described immediately above perform the following step (Step 1017): emptying a second reactor tank of its purified water contents (Step 1020) while filling the first reactor tank with the partially ozonated contaminated water and concurrently further ozonating the contaminated water as described above in Step 1015;
conveying partially ozonated contaminated water from the Venturi injector to the second reactor tank, wherein the water enters and fills the tank and, while filling the tank, the water therein is concurrently ozonated (Step 1025);
emptying the first reactor tank of its ozonated purified water contents (Step 1030) while filling the second reactor tank with the partially ozonated contaminated water and concurrently ozonating the contaminated water as described above in Step 1025; and
repeating all of the steps from the first step of conveying to the second step of emptying as many times as required to obtain the desired quantity of purified water. (Step 1040)

Not shown in FIGS. 1 and 3 is a sensor which can be used to determine if the carbon filters are losing their filtering ability. This sensor may, for example, indicate an increase in amperage used in water pumps 212, 214 (1 and 32 in FIG. 1) to move the water forward in the system. The amperage sensor is typically located in microprocessor/controller 202.

Also not shown in FIGS. 1 and 3 is a sensor in the controller which tracks power remaining in power sources such as batteries. If the sensor indicates that power is low the system can be shut down.

The system of the present invention has passed Israel Standard 1505 and is being tested using the NSF P231 protocol that deals with unsafe and unknown water sources. This should be contrasted with other NSF/ANSI standards that relate only to safe water sources.

It should readily be understood by persons skilled in the art that a plurality of reactor tanks may be used where the plurality may be more than two reactor tanks. It should also readily be understood that the microprocessor/controller will be modified accordingly to time the filling, ozonation and emptying of the three or more tanks to maximize water production. The valve system must also be modified to achieve the desired results.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. Therefore, it will be appreciated by persons skilled in the art that the present invention is not limited by what has been particularly shown and described herein above. Rather the scope of the invention is defined by the claims that follow.

1-24. (canceled)

25. A hand portable water purification system comprising:
a cold plasma ozone generator having two spaced apart electrodes for generating ozone;
a Venturi injector in fluid flow communication with a contaminated water source and linked to the cold plasma ozone generator, said generator providing ozone to said injector for mixing with contaminated water to form partially ozonated contaminated water (POCW);
a first reactor tank and a second reactor tank, each tank in fluid communication with said Venturi injector; and
a microprocessor/controller for controlling in real time the ozone produced by said generator.

26. A system according to claim 25, wherein the two spaced apart electrodes are parallel to each other.

27. A system according to claim 25, wherein the two spaced apart electrodes have holes positioned therein.

28. A system according to claim 25, wherein the ozone has an ozone concentration based on:
a ceramic dielectric layer of the two spaced apart electrodes having a given dielectric constant and a layer of a given thickness; or
a voltage frequency supplied to the cold plasma ozone generator.

29. A method for purifying water with a portable purification system comprising the steps of:
pumping air from an ambient atmosphere to a cold plasma ozone generator;
generating ozone by the cold plasma ozone generator from the pumped air;
pumping water from a contaminated water source to a Venturi injector;
mixing the generated ozone with the pumped water in the Venturi injector to form partially ozonated contaminated water (POCW);
filling a first reactor tank with the POCW;
mixing the generated ozone with the POCW inside the first reactor tank;
sensing a concentration of ozone discharged from the first reactor tank; and
detecting the concentration of the ozone discharged from the first reactor tank is equal to the ozone concentration of the generated ozone.

30. A method according to claim 29, wherein pumping air comprises pumping air from an ambient atmosphere to a cold plasma ozone generator configured such that the air passes perpendicularly through two parallel electrodes.

31. A method according to claim 29, further comprising:
sensing a first water level in the first reactor tank to indicate when filling of the first reactor tank with the POCW should be stopped; and
sensing a second water level in the first reactor tank to indicate when emptying of the POCW from the first reactor tank should be stopped.

32. A method according to claim 29, further comprising shutting off the cold plasma ozone generator responsive to detecting the concentration of the ozone discharged from the first reactor tank is equal to the ozone concentration of the generated ozone.

33. A method according to claim 29, further comprising shutting off the pumping of contaminated water responsive to detecting the concentration of the ozone discharged from the first reactor tank is equal to the ozone concentration of the generated ozone.

34. A method according to claim 29, further comprising opening an egress water valve of the first reactor tank responsive to detecting the concentration of the ozone discharged from the first reactor tank is equal to the ozone concentration of the generated ozone.

35. A method according to claim 34, further comprising:
filling a second reactor tank with the POCW from the Venturi injector while the egress water valve of the first reactor tank is open;
mixing the generated ozone with the POCW inside the second reactor tank;
sensing a concentration of ozone discharged from the second reactor tank; and
detecting the concentration of the ozone discharged from the second reactor tank is equal to the ozone concentration of the generated ozone.

36. A method according to claim 35 further comprising controlling, by a microprocessor/controller, the filling of the first reactor tank and the second reactor tank with POCW according to a predefined sequence so that a predefined amount of POCW and the generated ozone reaches the first reactor tank and the second reactor tank.

37. A hand portable water purification system comprising:
a cold plasma ozone generator comprising a first electrode generating ozone from oxygen;
a first sensor measuring ozone concentration in the cold plasma ozone generator;
a first valve regulating a flow of ozone from the cold plasma ozone generator to a Venturi injector;
a second valve regulating a flow of contaminated water from a contaminated water source to the Venturi injector, the Venturi injector producing partially ozonated contaminated water (POCW) from the generated ozone and the contaminated water;
a third valve regulating a flow of the POCW from the Venturi injector to a first reactor tank;
a fourth valve regulating a flow of ozone from the cold plasma ozone generator to the first reactor tank;
a second sensor measuring ozone concentration of the POCW inside the first reactor tank; and
a fifth valve regulating a flow of the POCW to a storage vessel based on the ozone concentration in the cold plasma ozone generator equaling the ozone concentration of the POCW.

38. A system according to claim 37, further comprising a microprocessor/controller controlling the cold plasma ozone generator, the Venturi injector, the first valve, the second valve, the third valve, the fourth valve, and the fifth valve.

39. A system according to claim 37, wherein the cold plasma ozone generator is configured so that air passes perpendicularly to the first electrode and a second electrode.

40. A system according to claim 37, further comprising a low wattage power source for providing less than 100 W of power to said system.

41. A system according to claim 40, wherein said cold plasma ozone generator is constructed so that the spacing between said electrodes, the electrode gap (EG), is equal to or less than 1 mm and equal to or more than 200 microns.

42. A system according to claim 41, wherein at least one of said parallel electrodes is coated with a ceramic dielectric layer on the side of the electrode or electrodes proximate to its electrode pair.

43. A system according to claim 41, wherein the energy used by the cold plasma ozone generator to purify water is equal to or greater than 90% of the energy from the power source.

44. A system according to claim 41, wherein the cold plasma ozone generator gives off less than 10% of its energy as heat.
